(19) United States
(12) Patent Application Publication
(10) Pub. No.: US 2010/0016519 A1
(43) Pub. Date: Jan. 21, 2010

(54) COLORED ORGANOPOLYSILOXANES

(76) Inventors: Werner Russ, Flörsheim-Wicker (DE); Roxana Barbieru, Frankfurt (DE); Stefan Ehrenberg, Hattesheim (DE); Gunter Görlitz, Sulzbach (DE); Christian Ochs, Burghausen (DE); Daniel Shildbach, Altotting (DE)

Correspondence Address: CONNOLLY BOVE LODGE & HUTZ, LLP, P O BOX 2207, WILMINGTON, DE, 19899, US

(21) Appl. No.: 12/443,406

(22) PCT Filed: Sep. 20, 2007
(86) PCT No.: PCT/EP2007/059955

§ 371 Date: Mar. 27, 2009

(30) Foreign Application Priority Data
Sep. 29, 2006 (DE) 10 2006 046 465.6

(51) Int. Cl. C08G 77/388

(52) U.S. Cl. 525/474

(57) ABSTRACT

Colored organopolysiloxanes comprising units of the formula

R¹ₐ(RO)_{b}A_{c}R²_{d}SiO_{(4-a-b-c-d)/2} (I),

in which
R is hydrogen or a monovalent, unsubstituted or substituted hydrocarbon radical, wherein R is identical or different among the units of the formula (I);
R¹ is hydrogen or a monovalent, SiC-bonded, unsubstituted or substituted hydrocarbon radical, wherein R¹ is identical or different among the units of the formula (I);
R² is a substituted monovalent hydrocarbon radical, wherein R² is identical or different among the units of the formula (I);
A is a hydrophilic organic dye radical or its complex compound with a metal, which contains at least one triazine ring via which it is bonded to the unit of the formula (I), wherein A is identical or different among the units of the formula (I);
a is 0, 1, 2 or 3;
h is 0, 1, 2 or 3;
d is 0,1, 2 or 3; and
c is 0, 1 or 2;
wherein a+b+c+d≦3;
wherein d is 0 in the units of the formula (I) where c is not 0; and
wherein the organopolysiloxane has at least one radical A per molecule.

The present invention relates to functionalized silicone compounds to which, in addition, chromophoric molecules are covalently attached, to processes for preparing them, and to the use of these colored silicone compounds.

The simultaneous use of silicon compounds and dyes is problematic owing to the lo immiscibility or insolubility of the majority of dyes in silicon compounds. The lack of compatibility between the two classes of substance therefore often leads to inhomogeneously colored products and/or to slow exudation of one of the product's components, and hence to product properties that are negative overall. The use of defined physical blends of dyes with specific silanes and/or siloxanes, as described is for example in U.S. Pat. No. 5,281,240, may counter these adverse consequences to a certain degree, but cannot be used for long-lasting prevention of separation of the individual components.

The problem can be solved, in contrast, if the dye molecule is bonded chemically to an organosilicon compound.

Thus it is the case that silanes with a dye content have been known for a number of decades. They are a topic of numerous monographs and patents (in this regard see, for instance, J. Soc. Dyers and Col. 1969, 85 (9), pp. 401-404).

Dye-carrying silanes are described for the first time by U.S. Pat. No. 2,925,313. In that case the conventional synthesis of azo dyes via azo coupling is modified by employing aniline-modified silanes as a coupling component. According to GB 2018804, phenyl-containing silanes are also suitable for this purpose. The silane-containing dyes obtained in this way are subsequently polymerized to give the corresponding polysiloxanes.

EP 0336709 A2 discloses organopolysiloxanes having triazine-containing radicals, which act as optical brighteners for synthetic fibers and paper. In this instance the bond is forged through the reaction of a sulfonic acid group of the optical brightener with an amino-functional silane or siloxane, to give the sulfonamide.

Silicone compounds with nitroaromatic dye radicals can be obtained, according to U.S. Pat. No. 4,403,099, by reacting epoxy-functional siloxanes under basic conditions with amine- or sulfonamide-containing nitro dyes. As an alternative to this, U.S. Pat. No. 4,405,801 proposes bonding ring-halogenated aromatic nitro dyes to amino-functional siloxanes by means of nucleophilic substitution on the aromatic ring.

A feature common to all of the abovementioned preparation processes is that they are restricted either only to selected dyes or dye precursors, such as aniline-containing azo compounds, amine-, sulfonic acid- or sulfonamide-containing chromophores, and unhalogenated or halogenated nitroaromatics, for example, or exclusively to specific silicone oils. Moreover, on account of the preparation processes employed, which require highly specific and in some cases highly drastic reaction conditions, the siloxanes disclosed in the cited patent literature also do not contain any further functional groups. Additional disadvantages, furthermore, are the use of toxicologically objectionable chromophores based on aniline or nitroaromatics, the reaction yields, which are often very low, and the relatively complicated syntheses over two or more reaction steps.

EP 0960153 A1 has already described the preparation of organopolysiloxanes comprising dye radicals through the reaction of nucleophilic polysiloxanes with water-soluble reactive dyes containing sulfonic acid groups and/or sulfonate groups. A basis of this synthesis process is the use of polar, water-soluble reactive dyes which are therefore hydrophilic, with the need either for a heterogeneous reaction regime, or the use of relatively large volumes of compatibilizing solvents. This method makes it possible to prepare organopolysiloxanes with covalently bonded dye radicals in various colors and depths of color.

However, in use, these products have various disadvantages, for example, with respect to UV and temperature stability.

Thus there is a need for colored organopolysiloxanes with improved properties.

The present invention provides colored organopolysiloxanes comprising units of the formula

R¹ₐ(RO)_{b}A_{c}R²_{d}SiO_{(4-a-b-b-d)/2} (I),

in which

R can be identical or different and is hydrogen or a monovalent, unsubstituted or substituted hydrocarbon radical;

R¹ can be identical or different and is hydrogen or a monovalent, SiC-bonded, unsubstituted or substituted hydrocarbon radical;

R² can be identical or different and is a substituted monovalent hydrocarbon radical;

A can be identical or different and is a hydrophilic organic dye radical or its complex compound with a metal, which contains at least one triazine ring via which it is bonded to the unit of the formula (I);

a is 0, 1, 2 or 3;

b is 0, 1, 2 or 3;

d is 0, 1, 2 or3; and

c is 0, 1 or 2;

with the proviso that the sum a+b+c+d is≦3, the organopolysiloxanes have at least one radical A per molecule, and in the units of the formula (I) where c is other than 0 d is 0.

In the context of the present invention, the term organopolysiloxanes embraces not only polymeric but also oligomeric and dimeric siloxanes.

R is preferably hydrogen or a hydrocarbon radical having 1 to 18, in particular 1 to 8, carbon atoms, which may be substituted and/or interrupted by one or more oxygen atoms.

Examples of R are (C₁-C₁₈)-alkyl radicals, such as methyl, ethyl, n-propyl, isopropyl, n-butyl, sec-butyl, isobutyl, tert-butyl, n-pentyl, isopentyl, neopentyl, tert-pentyl radical, hexyl, particularly n-hexyl, heptyl, particularly n-heptyl, octyl, particularly n-octyl and isooctyl, such as 2,2,4-trimethylpentyl, nonyl, particularly n-nonyl, decyl radicals, particularly n-decyl, dodecyl, particularly n-dodecyl, and octadecyl, particularly n-octadecyl; (C₃-C₁₀)-cycloalkyl radicals, such as cyclopentyl, cyclohexyl, cycloheptyl, and methylcyclohexyl; (C₂-C₆)-alkenyl radicals, such as vinyl, 1-propenyl and 2-propenyl; aryl radicals, such as phenyl, naphthyl, anthryl, and phenanthryl;

(C₁-C₄)-alkylaryl radicals, such as o-, m-, and p-tolyl, xylyl, and ethylphenyl; and aryl-(C₁-C₄)-alkyl radicals, such as benzyl radical and α- and β-phenylethyl.

More preferably R is hydrogen, methyl, ethyl, vinyl or propyl.

R¹ is preferably hydrogen or a hydrocarbon radical having 1 to 18, in particular 1 to 8 carbon atoms, which may be substituted and/or interrupted by one or more oxygen atoms.

Examples of R¹ are the radicals specified for R. More preferably R¹ is methyl.

R² is preferably a substituted hydrocarbon radical having 1 to 18 carbon atoms, which is substituted with particular preference by amino, hydroxyl, epoxy, mercapto, carboxyl or derivatives thereof.

Examples of R² are

a) hydrocarbon radicals substituted by amino groups and derivatives thereof, such as aminomethyl, phenylaminomethyl, aminopropyl, aminoethylaminopropyl, cyclohexylaminopropyl and acylated aminopropyl, for example;

b) hydrocarbon radicals substituted by hydroxyl groups, such as primary, secondary or tertiary alcohol radicals, such as 3-hydroxypropyl and 4-hydroxybutyl, or hydrocarbon radicals which carry aromatic hydroxyl groups, such as the phenol or eugenol radical, for example;

c) hydrocarbon radicals substituted by mercapto groups, such as 3-mercaptopropyl, for example;

d) hydrocarbon radicals substituted by epoxy groups, such as those, for example, from the group consisting of

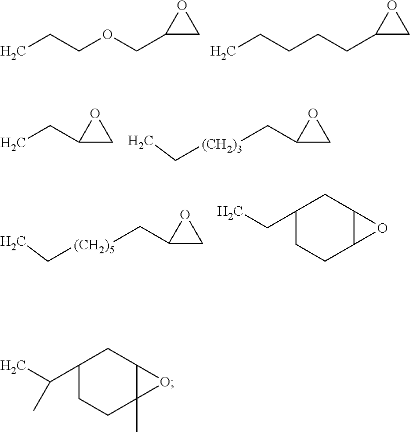

e) hydrocarbon radicals substituted by carboxylic acid groups or derivatives thereof, such as, for example, alkanoic acid radicals, such as the acetyl, 3-carboxypropyl, 4-carboxybutyl, 10-carboxydecyl, and 3-(ethane-1,2-dicarboxyl) propyl radical, acid anhydride radicals, such as the 3-(2,5-dioxotetrahydrofuranyl)propyl radical, and ester radicals, such as the undecene silyl ester radical;

f) hydrocarbon radicals substituted by carbonyl groups, such as ketone-functional radicals and aldehyde-functional radicals, such as the propionaidehyde radical, for example;

g) hydrocarbon radicals substituted by acrylate or methacrylate groups, such as 3-acryloyloxypropyl and 3-methacryloyloxypropyl, for example;

h) SiC- or SiOC-bonded hydrocarbon radicals substituted by polyether groups, such as those derived from polyethylene glycol, polypropylene glycol, poly-(1,4-butanediol) and copolymers thereof, such as the propylpolyglycol radical, for example;

i) hydrocarbon radicals substituted by quaternary nitrogen atoms, such as —(CH₂)₃—N(CH₃)₃⁺X⁻ and —(CH₂)₃—NH—CH₂—CH(OH)—CH₂—N(CH₃)₂C₁₂H₂₅⁺X⁻, for example X⁻ being a suitable anion;

j) hydrocarbon radicals substituted by phosphonato groups, such as phosphonatoalkyl radicals, for example;

k) hydrocarbon radicals substituted by silalactone groups;

l) hydrocarbon radicals substituted by glycoside groups, such as those, for example, in which the glycoside radical, which may be composed of 1 to 10 monosaccharide units, is attached via an alkylene or oxyalkylene spacer.

A dye radical represented by A is preferably sulfonic acid group- and/or sulfonate group-containing and the radical of an azo, anthraquinone, oxyquinophthalone, coumarin, naphthalimide, benzoquinone, naphthoquinone, flavone, anthrapyridone, quinacridone, xanthene, thioxanthene, benzoxanthene, benzothioxanthene, perylene, perinone, acridone, phthalocyanine, methine, diketopyrrolopyrrole, triphendioxazine, phenoxazine, or phenothiazine dye or of a metal complex compound thereof, and contains preferably 1, 2, 3 or 4 triazine groups. Dye radicals with 1 or 2 triazine groups are especially preferred.

Metal complex compounds are more particularly copper, chromium, cobalt or nickel complex compounds.

The dye radicals A are bonded to the units of the formula (I) via one or more triazine groups. If a dye radical A contains more than one triazine group it may also join two or more sil(oxan)yl radicals to one another.

Other than one or more triazine groups, the dye radical A preferably contains no further reactive groups via which attachment to the unit of the formula (I) would be possible. With particular preference it is free from reactive anchors of the vinyl sulfone type. By reactive anchors of the vinyl sulfone type are meant groups of the formulae —SO₂CH═CH₂ and —SO₂CH₂CH₂Z in which Z is an alkali-eliminable substituent.

Examples of alkali-eliminable substituents Z are halogen atoms, such as chlorine and bromine, ester groups of organic carboxylic and sulfonic acids, such as alkyl lo carboxylic acids, unsubstituted or substituted benzene carboxylic acids, and unsubstituted or substituted benzenesulfonic acids, such as the groups alkanoyloxy of 2 to 5 carbon atoms, including in particular acetyloxy, benzoyloxy, sulfobenzoyloxy, phenylsulfonyloxy and tolylsulfonyloxy, and also acid ester groups of inorganic acids, such as of phosphoric acid, sulfuric acid, and thiosulfuric acid (phosphate, sulfato, and thiosulfato groups), and also dialkylamino groups with alkyl groups each of 1 to 4 carbon atoms, such as dimethylamino and diethylamino. The dye radicals A are therefore preferably attached exclusively via one or more triazine groups to the units of the formula (1).

Dye radicals A preferably conform to the formula A0

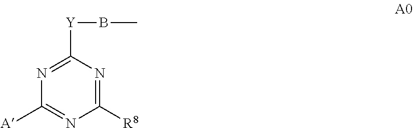

in which

Y is —O—, —S— or —NR³ and R³ is hydrogen or (C₁-C₄)-alkyl;

B is a divalent bridge member;

A′ is a chromophoric structure; and

R⁸ is A′ or is an organic radical.

An organic radical R⁸ is, for example, —NR⁹R¹⁰, —NHSO₂R¹¹, —NHC(O)R¹², —OR¹³ or —SR¹⁴, in which R⁹ to R¹⁴ independently of one another are alkyl, hydroxyalkyl, polyhydroxyalkyl, arylalkyl, alkoxyalkyl, thioalkoxyalkyl, poly(oxyalkylene)alkyl, aminoalkyl, N-monoalkylaminoalkyl, N-monoarylaminoalkyl, N,N-dialkylaminoalkyl, N,N-diarylaminoalkyl, N-alkyl-N-arylaminoalkyl, aminohydroxyalkyl, alkoxyalkylaminoalkyl, thioalkoxyalkylaminoalkyl, aminoalkyloxyalkyl, N-monoalkylaminoalkyloxyalkyl, N,N-dialkylaminoalkoxyalkyl, N-arylaminoalkoxyalkyl, N,N-diarylaminoalkoxyalkyl, N-alkyl-N-arylaminoalkoxyalkyl, aminoalkylthioxyalkyl, N-monoalkylaminoalkylthioxyalkyl, N,N-dialkylaminoalkylthioxyalkyl, N-arylaminoalkylthioxyalkyl, N,N-diarylaminoalkylthioxyalkyl, N-alkyl-N-arylaminoalkylthioxyalkyl, cycloalkyl, cycloalkylalkyl, aryl, substituted aryl, heteroaryl, substituted heteroaryl, heteroarylalkyl, heterocycloalkyl or heterocycloalkylalkyl; and R⁹, R¹⁰, R¹³, and R¹⁴ can also be hydrogen; and R⁶and R⁷ can also form a 5- or 6-membered heterocycle with the nitrogen atom to which they are attached.

Alkyl radicals specified here have preferably 1 to 6 and more preferably 1 to 4 carbon atoms, and thus for instance are methyl, ethyl, propyl, butyl, pentyl or hexyl.

Cycloalkyl groups are more particularly cyclopentyl and cyclohexyl. Aryl groups are more particularly phenyl and naphthyl.

Examples of dye radicals A are in particular the radicals A1 to A16 below.

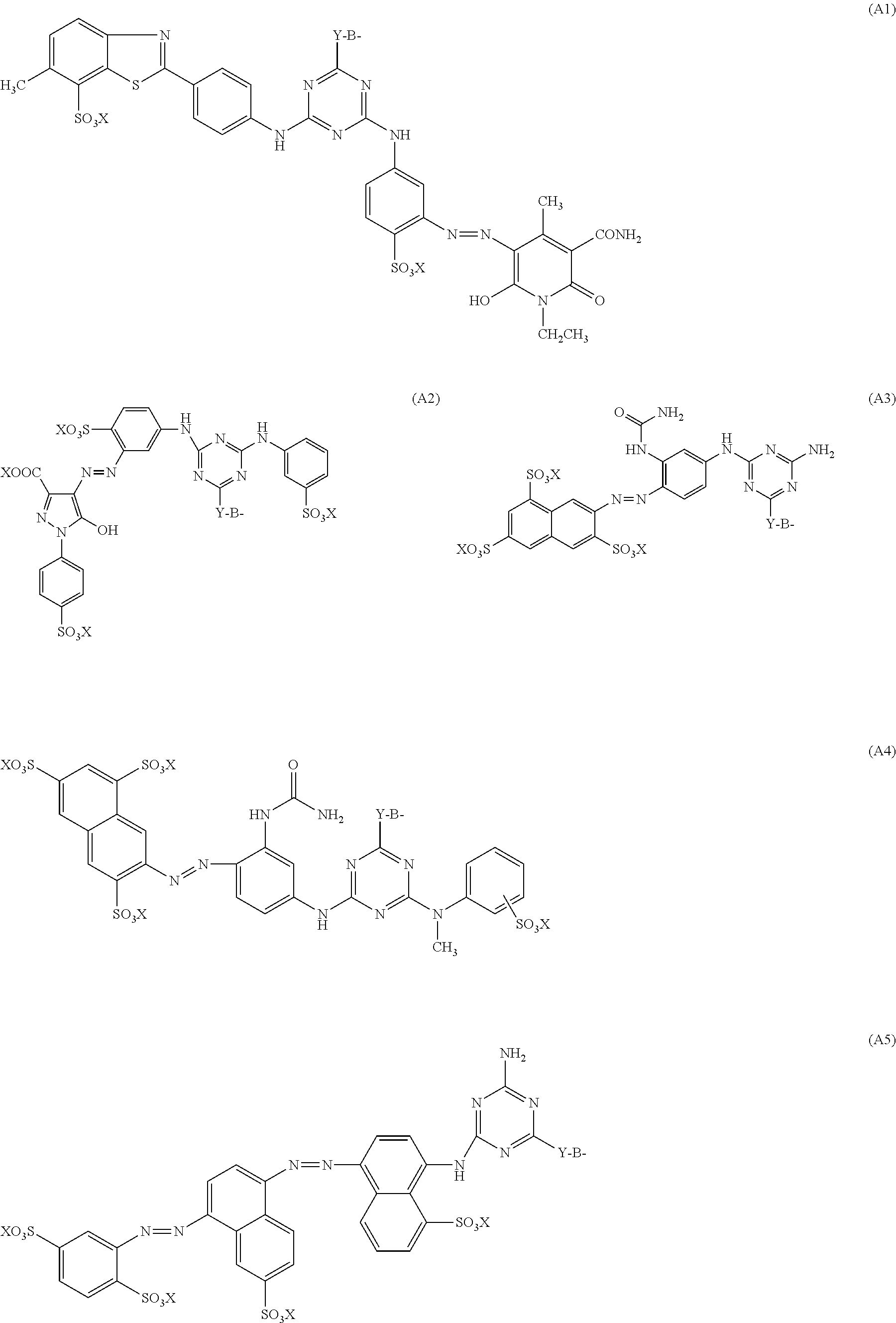

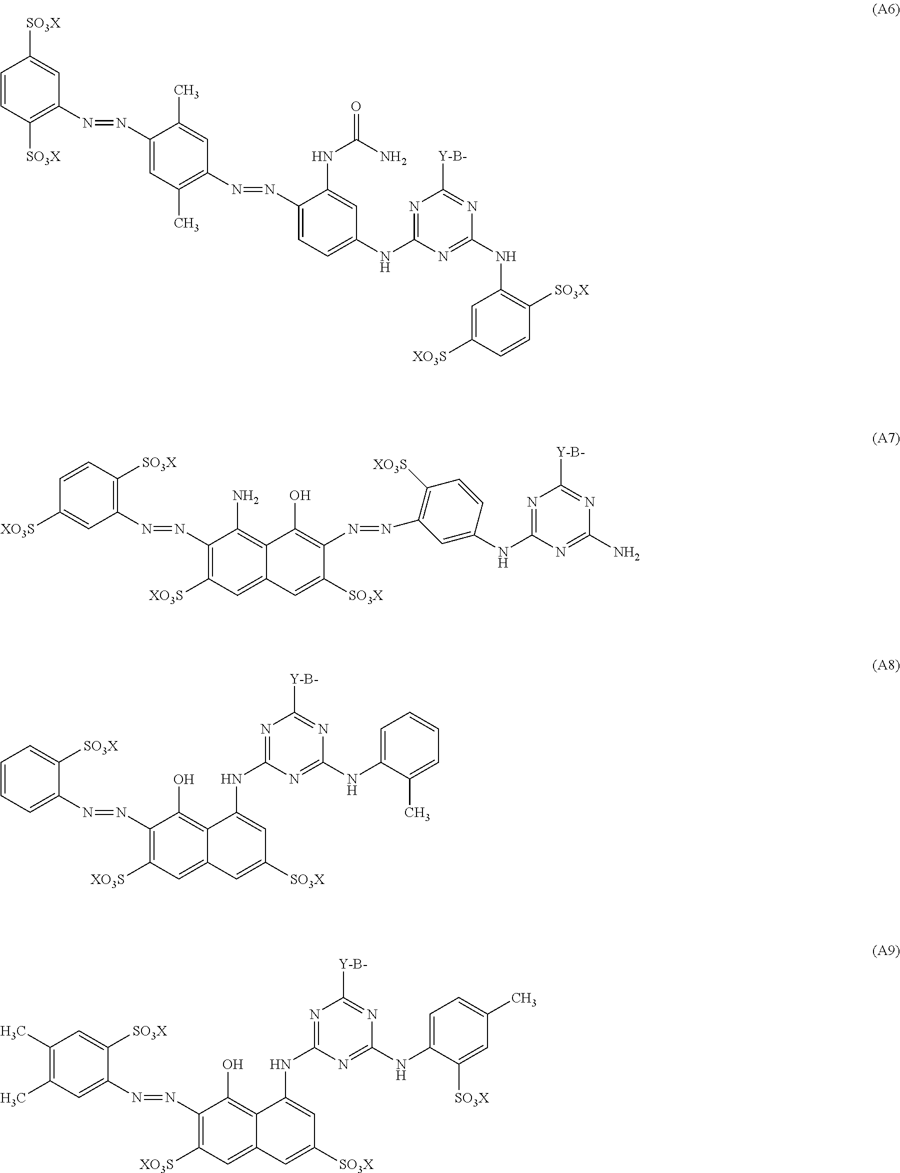

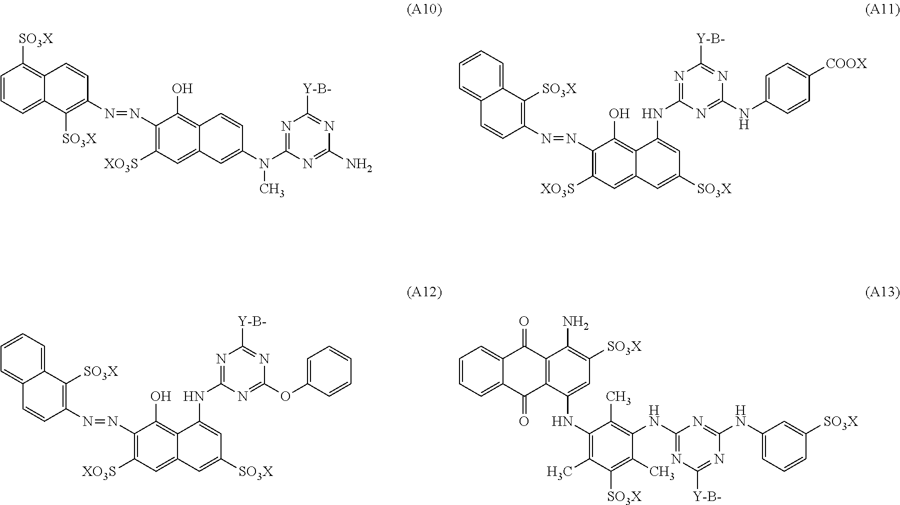

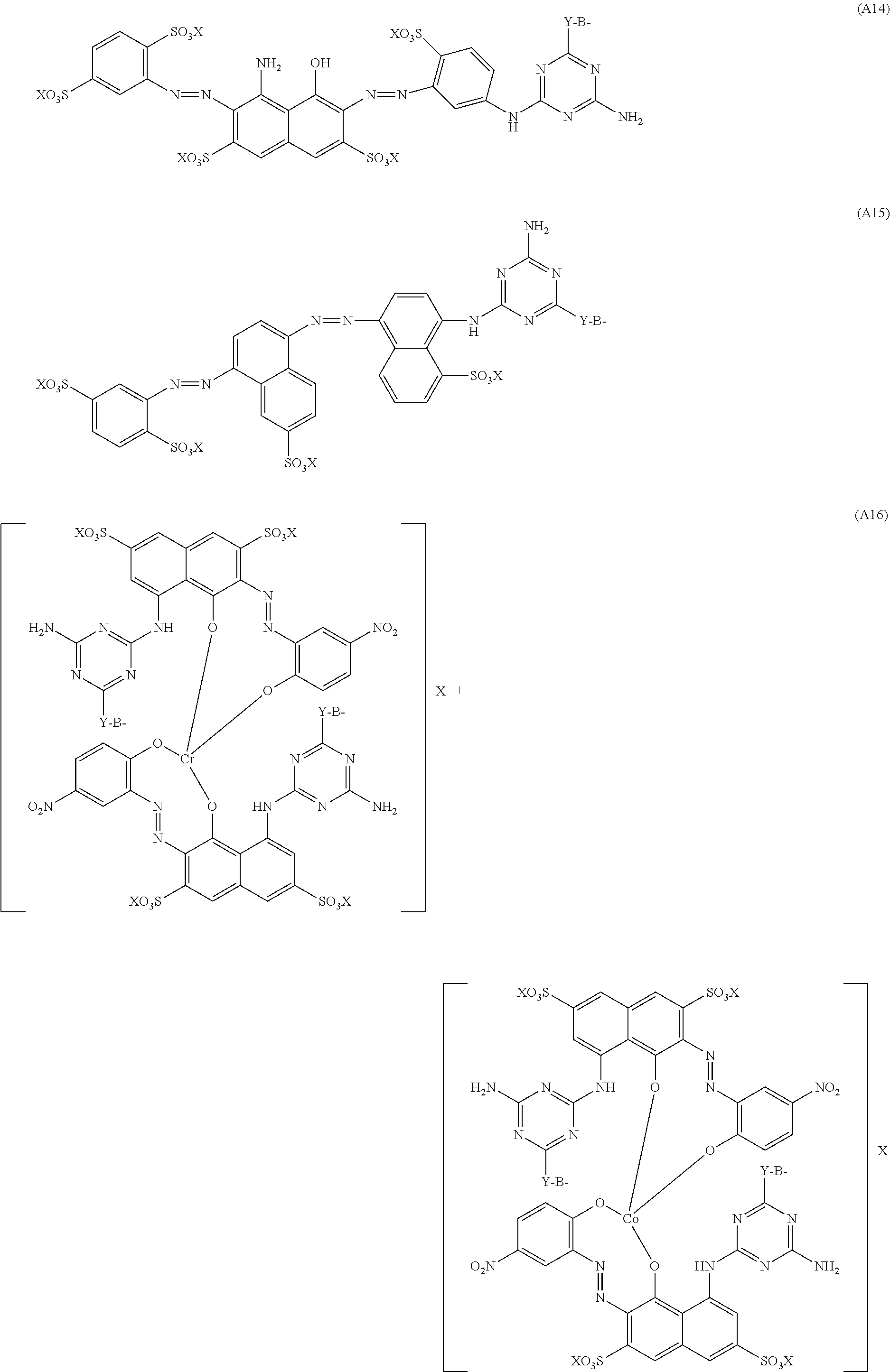

in which

Y is —O—, —S— or —NR³— and R³ is hydrogen or (C₁-C₄)-alkyl;

B is a divalent bridge; and

X is hydrogen, an alkali metal, an equivalent of an alkaline earth metal or an organic cation.

R³ is in particular hydrogen, methyl or ethyl.

B connects the dye chromophore to a silicon atom and is preferably a hydrocarbon radical, which may be unsubstituted or substituted and/or interrupted by one or more heteroatoms, such as oxygen, nitrogen, and sulfur.

B is preferably a divalent linear (C₁-C₃₀)-hydrocarbon radical unsubstituted or substituted and/or interrupted by one or more heteroatoms, such as oxygen, nitrogen, and sulfur. Particular preference is given to unsubstituted or substituted (C₁-C₁₀)-alkylene radicals, such as methylene, ethylene, propylene, butylene, aminopropyl-aminoethyl, the ethylene oxide radical, and also alkylene groups substituted by a maximum of 4 sugar radicals.

An organic cation X is for example a cyclic or noncyclic ammonium, phosphonium or sulfonium cation. Particularly preferred are cyclic and noncyclic ammonium cations of the formula (II)

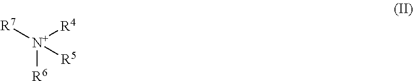

where, in the case of noncyclic cations,

R⁴ to R⁷ independently of one another are alkyl, aryl, arylalkyl, cycloalkyl, cycloalkylalkyl, heteroaryl, heteroarylalkyl, heterocycloalkyl or heterocycloalkylalkyl, which if desired may be substituted and/or interrupted by one or more heteroatoms, such as oxygen, nitrogen, and sulfur.

Alkyl R⁴ to R⁷ may be branched or unbranched and is more particularly (C₁-C₂₂)-alkyl. Cycloalkyl is preferably (C₃-C₈)-cycloalkyl and more particularly cyclopentyl and cyclohexyl. Aryl is preferably phenyl or naphthyl.

Particularly preferred noncyclic cations X are of the formulae (IIa) to (IIe)

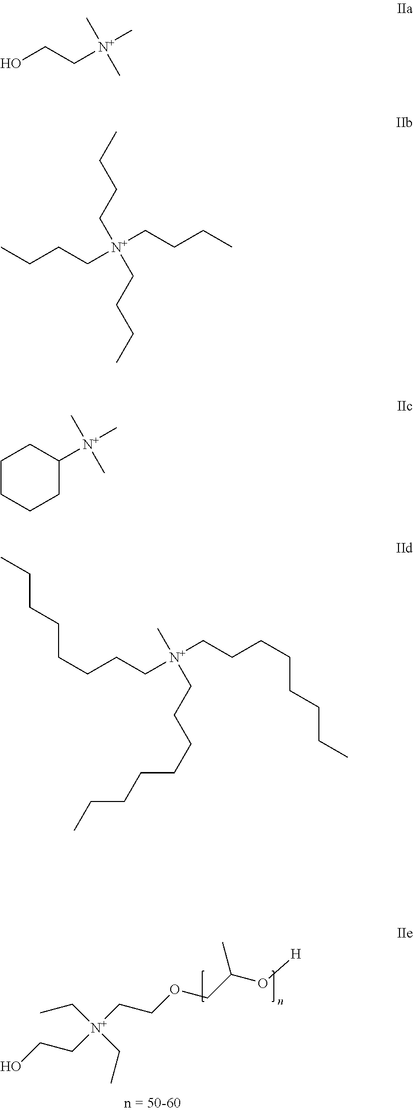

In the case of cyclic cations of the formula (II), R⁴ and R⁵, together with the nitrogen atom to which they are attached, form a 5- or 6-membered ring, which is unsubstituted or substituted, and

R⁶ and R⁷ are defined as indicated above for noncyclic cations.

5- or 6-membered rings formed by R⁴ and R⁵ together with the nitrogen atom to which they are attached are more particularly imidazolium, pyridinium, pyrrolinium, pyrrolidinium, thiazolium, quinolinium, oxazolium, isoxazolium, pyrazolium, piperidinium, morpholinium, pyrimidinium, pyrazinium, indolium, and isoquinolinium rings.

Particularly preferred cyclic ammonium cations of the formula (II) have the formulae (IIf) to (IIk)

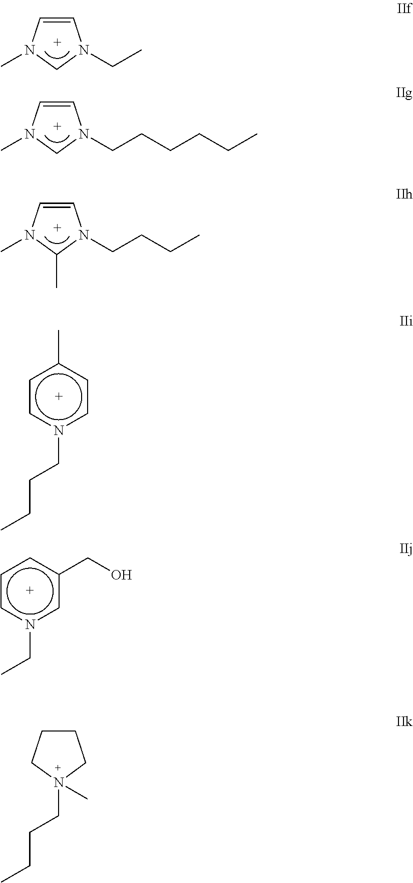

X is preferably hydrogen, sodium, potassium or a cation of the formulae (IIa) to (IIk).

In the units of the formula (l) c is preferably 0 or 1 and d is likewise 0 or 1, with d being 0 if c is 1.

Preferred organopolysiloxanes of the invention are those in which in at least 50%, more preferably in at least 80%, and very preferably in at least 90% of all of the units of the formula (I) the sum of a+b+c+d is 2.

Particularly preferred organopolysiloxanes of the invention are of the formula (III)

R¹₃SiO(SiA₂O)ₑ(SiR¹_{f}R²_{2-f}O)_{g}(R²ₘR¹₂₋ₘSiO)ₕ(R¹ⱼAR²₁₋ⱼSiO)ₖSiR¹₃ (III)

in which R¹, R² and A are defined as specified above;

f is 0 or 1, preferably 1;

j is 0 or 1, preferably 1;

m is 0, 1 or 2, preferably 0;

e is 0 or an integer from 1 to 100;

g is 0 or an integer from 1 to 100;

h is 0 or an integer from 1 to 1000; and

k is an integer from 1 to 100;

with the proviso that (e+g)<(h+k)/10 and the units in the formula (la) are distributed randomly in the siloxane molecule.

The viscosities of the organopolysiloxanes of the invention range from preferably 100 mm²/s through to a waxlike, solid consistency at room temperature. Particular preference is given to the viscosity range between 1000 mm²/s and 20 000 mm²/s, and also the range of waxlike solid consistency at room temperature.

The dye content of the organopolysiloxanes of the invention is preferably 0.1% to 80% by weight, more preferably 1% to 15% by weight, in particular 5% to 10% by weight, based in each case on the total weight.

The organopolysiloxanes of the invention have the advantage that apart from the covalently bonded dye radicals they may also have further functional groups, which may endow the compound, additionally to the color, with further properties, such as substantivity, hydrophilicity or hydrophobicity, chemical reactivity, etc., for example. The organopolysiloxanes of the invention have the advantage, furthermore, that they are stable, in other words that they undergo no substantive alteration for at least one year at room temperature and at the pressure of the surrounding atmosphere. A further advantage of the organopolysiloxanes of the invention, finally, is that, with their assistance, hydrophobic systems, such as silicone rubber compositions, for instance, can be colored very easily.

In comparison to the organopolysiloxanes containing dye radicals that were described in EP 0960153 A1, the organopolysiloxanes of the invention have superior and in some cases outstanding thermal stability and light stability, and so can be used for a very wide variety of applications.

The organopolysiloxanes of the invention can be prepared by reacting a hydrophilic organic dye of the formula IV

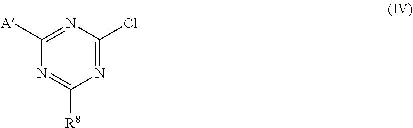

in which A′ is a chromophoric structure; and

R⁸ is A′ or an organic radical;

with an organopolysiloxane containing functional groups which are able to form a covalent bond with the chlorotriazine group of the dye. The stated dye, accordingly, s is a reactive dye.

An organic radical R⁸ is, for example, —NR⁹R¹⁰, —NHSO₂R¹¹, —NHC(O)R¹², —OR¹³ or —SR¹⁴, in which R⁹ to R¹⁴ independently of one another are alkyl, hydroxyalkyl, polyhydroxyalkyl, arylalkyl, alkoxyalkyl, thioalkoxyalkyl, poly(oxyalkylene)alkyl, aminoalkyl, N-monoalkylaminoalkyl, N-monoarylaminoalkyl, N,N-dialkylaminoalkyl, N,N-diarylaminoalkyl, N-alkyl-N-arylaminoalkyl, aminohydroxyalkyl, alkoxyalkylaminoalkyl, thioalkoxyalkylaminoalkyl, aminoalkyloxyalkyl, N-monoalkylaminoalkyloxyalkyl, N,N-dialkylaminoalkoxyalkyl, N-arylaminoalkoxyalkyl, N,N-diarylaminoalkoxyalkyl, N-alkyl-N-arylaminoalkoxyalkyl, aminoalkylthioxyalkyl, N-monoalkylaminoalkylthioxyalkyl, N,N-dialkylaminoalkylthioxyalkyl, N-arylaminoalkylthioxyalkyl, N,N-diarylaminoalkylthioxyalkyl, N-alkyl-N-arylaminoalkylthioxyalkyl, cycloalkyl, cycloalkylalkyl, aryl, substituted aryl, heteroaryl, substituted heteroaryl, heteroarylalkyl, heterocycloalkyl or heterocycloalkylalkyl; and R⁹, R¹⁰, R¹³, and R¹⁴ can also be hydrogen; and R⁶ and R⁷ can also form a 5- or 6-membered heterocycle with the nitrogen atom to which they are attached.

Alkyl radicals specified here have preferably 1 to 6 and more preferably 1 to 4 carbon atoms, and thus for instance are methyl, ethyl, propyl, butyl, pentyl or hexyl.

Cycloalkyl groups are more particularly cyclopentyl and cyclohexyl. Aryl groups are more particularly phenyl and naphthyl.

The dye is used in amounts of preferably 0.1% to 900% by weight, more preferably 1% to 100% by weight, in particular 5% to 35% by weight, based in each case on the total weight of organopolysiloxane employed. It is advisable in this context to limit the molar amount of dyes to a maximum of 99.9 mol % of the functional groups present in the organopolysiloxane employed.

Individual dyes may be used, but so may mixtures of two, three or more dyes.

The dye is used in the process of the invention are known dyes which can be prepared by the methods that are commonplace in organic chemistry and are known to the skilled worker.

Functional groups of the organopolysiloxane which are able to react with chlorotriazine groups of the dye are, in particular, amino, mercapto, hydroxyl, carboxyl, acrylate, methacrylate, carbonyl, polyether, and phosphonato, or groups which have glycoside, anhydride, epoxy, primary, secondary or tertiary carbinol, phenol, aldehyde, polyglycol or silalactone groups or which have quaternary nitrogen. In particular, groups of this kind are primary and secondary amino, mercapto, hydroxyl and carboxyl groups.

Organopolysiloxanes which have such functional groups and are used in the process of the invention are known products which are available commercially or which are preparable by the methods that are commonplace in silicon chemistry and are known to the skilled worker.

As an example, mention may be made of organosiloxanes which comprise units of the formula (I′)

R¹ₐ(RO)_{b}R′_{c}R²_{d}SiO_{(4-a-b-c-d)/2} (I′),

in which R, R¹, R², a, b, and d are defined as indicated above and R′ can be identical or different and is an amino, mercapto, hydroxyl, carboxyl, acrylate, methacrylate, carbonyl, polyether and phosphonato or groups containing glycoside, anhydride, epoxy, primary, secondary or tertiary carbinol, phenol, aldehyde, polyglycol and/or silalactone-functional hydrocarbon radical, and c′ is as defined for c, with the proviso that the sum of a+b+c′+d is 3, the organopolysiloxanes have at least one radical R′ per molecule, and in the units of the formula (I′) where c′ is other than 0 d is 0.

Examples of radicals R′ are the radicals given above for the radical R², preference being given to hydrocarbon radicals substituted by amino groups and derivatives thereof, such as aminomethyl, phenylaminomethyl, aminopropyl, 3-(2-aminoethylamino)propyl, and cyclohexylaminopropyl, for example, hydrocarbon radicals substituted by hydroxyl groups, such as primary, secondary or tertiary alcohol radicals, such as the 3-hydroxylpropyl and 4-hydroxybutyl radical, for example, hydrocarbon radicals carrying aromatic hydroxyl groups, such as the phenol or eugenol radical, for example, hydrocarbon radicals substituted by mercapto groups, such as the 3-mercaptopropyl radical, for example, hydrocarbon radicals substituted by carboxylic acid groups or derivatives thereof, such as alkanoic acid radicals, for example, such as the acetyl, 3-carboxypropyl, 4-carboxybutyl, 10-carboxydecyl, and the 3-(ethane-1,2-dicarboxyl)propyl radical.

The organic polysiloxanes which carry amino groups, employed with particular preference in accordance with the invention, are more particularly organopolysiloxanes having an amine number of 0.01 to 10.0, the amine number corresponding to the number of mL of a 1N HCl needed to neutralize 1 g of substance.

The viscosities of the organopolysiloxanes employed in accordance with the invention range from preferably 50 to 50 000 mm²/s, more preferably from 200 to 15 000 mm²/s, in each case at 25° C.

In the process of the invention there is a nucleophilic substitution on the triazine ring of the dye, in accordance for example with the following equation:

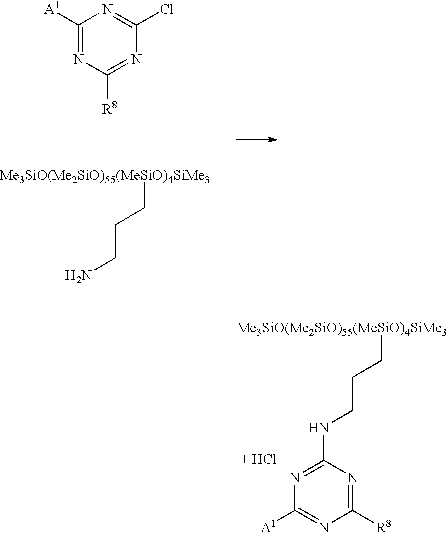

Depending on reaction conditions, however, it is also possible for a sulfonamide formation reaction to occur as well, in accordance for example with the following equation:

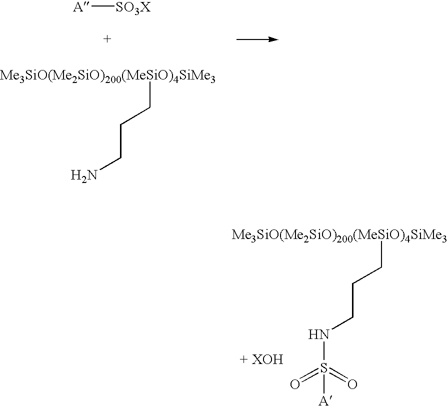

where A″ is the radical of the dye employed in each case.

The process of the invention can be carried out in the presence or absence of catalysts, the use of catalysts being preferred. If catalyst is used, the catalysts in question can be acidic or basic. Basic catalysts are preferred. These catalysts may be used either without solvent or in the form of their solutions.

Examples of acidic catalysts are Brensted acids, such as phosphoric acid, sulfuric acid, hydrochloric acid, glacial acetic acid, and formic acid, or Lewis acids, such as lithium perchiorate, zinc tetrafluoroborate, iron(II) chloride, tin(IV) chloride, and Lewis-acidic ionic liquids.

Examples of basic catalysts are primary, secondary or tertiary amines, basic pyridine, pyrimidine, quinoline, pyridazine, pyrazine, triazine, indole, imidazole, pyrazole, triazole, tetrazole, pyrrole, oxazole, thiazole and/or other N-containing heterocyclic derivates, basic ammonium salts, such as benzyltrimethylammonium is hydroxide and tetraalkylammonium hydroxide, alkali metal hydroxides, alkaline earth metal hydroxides, alkali metal alkoxides, alkali metal amides, and Lewis-basic ionic liquids.

If a catalyst is used in the reaction of the invention, the amounts involved are preferably 0.1% to 1% by weight, based on the total weight of the reactants.

The process of the invention can be carried out as a one-phase reaction (C) or as a two-phase reaction (A). Two-phase reactions may also be reactions in emulsion (B).

In the case of a two-phase reaction with mechanical energy input for homogenization (process A) the reaction of dye with organopolysiloxane takes place with the use of solvents which are immiscible with one or both reactants, so that two phases are formed, and by means of suitable mixing methods, without catalyst or with basic catalysis.

For the purposes of the present invention the concept of the immiscibility of solvents means a miscibility of up to but not more than 1% by weight at 25° C. and the pressure of the surrounding atmosphere,

The reaction of the invention according to process A is carried out at a temperature of preferably 0 to 200° C., more preferably 50 to 160° C., in particular 80 to 130° C., and preferably at the pressure of the surrounding atmosphere, in other words at 900 to 1100 hPa. The reaction times are preferably between 5 minutes and 2 hours, more preferably between 5 and 15 minutes. Suitable solvents for the dye used in accordance with the invention, the solvents being inert toward the reactive groups of the dye, are organic aprotic solvents, water, aqueous electrolyte solutions, aqueous alkalis or organic-aqueous mixtures of the aforementioned aprotic organic solvents with aqueous systems. Preferred aprotic organic solvents are dimethylformamide and dimethyl sulfoxide. Preferred aqueous systems are aqueous alkalis.

Suitable solvents for the organopolysiloxane used in accordance with the invention are organic aprotic solvents that are inert toward the reactants, such as toluene, hexane, cyclohexane or dimeric, oligomeric or polymeric siloxanes, such as hexamethyldisiloxane, which are not miscible with the solvent or with the solvent mixture of the dye used in accordance with the invention.

All known mixing methods, including continuous mixing methods, that achieve maximum homogenization of the two immiscible phases and hence a high internal reaction surface area can be employed. Suitable methods of dispersing phases are stirrers of all kinds, preferably ultrasound probes or ultrasound baths and high-speed stirrer mechanisms, particular preference being given to high-speed stirrer mechanisms, such as Ultra-Turrax stirrers (Janke & Kunkel, IKA® Labortechnik, Ultra-Turrax T50 (1100 W 10 000 min⁻¹). Process A has the advantage that there is no longer any need to work up the colored organopolysiloxanes obtained in accordance with the invention. Furthermore, process A has the advantage that it can be carried out without solubilizers, such as primary alcohol, and without surface-active substances, such as surfactants.

An alternative process consists in a two-phase reaction which is characterized by reactions of dispersions, such as emulsions or microemulsions (process B).

In this case the organopolysiloxane used in accordance with the invention forms the dispersed phase in the aqueous liquor and is stabilized in a known way, such as by suitable emulsifiers, for instance, The dye used in accordance with the invention is dissolved in a suitable solvent, preferably water or dilute aqueous electrolyte solutions, and is added to a dispersion, or vice versa. The reaction proceeds optionally without catalyst, or with basic or acidic catalysis. With regard to the catalysts, the comments made above apply.

The reaction of the invention according to process B is carried out at a temperature of preferably 0 to 100° C., more preferably at 10 to 50° C., in particular at 20 to 35° C., and preferably under the pressure of the surrounding atmosphere, i.e., at 900 to 1100 hPa. The reaction times are preferably between one and 200 hours, and the dispersion can to be mixed during reaction.

Dispersion comprising the organopolysiloxane used in accordance with the invention can be prepared in any conventional way whatsoever. For example, all of the emulsifiers that have also been used to date to prepare dispersions can be used, such as nonionic, anionic, cationic or amphoteric emulsifiers, for instance.

The dispersions used in accordance with the invention have a siloxane fraction of preferably 1 to 30 percent by weight. Particularly suitable as the dispersed siloxane phase are organosiloxane oils, containing aminoalkyl groups used in accordance with the invention, having a viscosity of between 100 and 10 000 mm²/s and an amine number of between 0.2 and 2, it being possible for some of the aminoalkyl groups to be in protonated form.

After the end of the reaction, the dispersion comprising the organopolysiloxanes of the invention can be worked up by methods that are known per se, such as by breaking the dispersion of concentrated electrolyte solutions or by addition of water-soluble polar solvents, such as acetone. Preferably the oil phase is then separated off and is subsequently purified by repeated extraction by shaking with concentrated electrolyte solutions, such as with 20% strength by weight sodium chloride solution, for example. The organopolysiloxanes of the invention obtained in this way are then preferably dried. If, however, dispersions of the invention are to be put to direct further use, it is possible for work-up, of course, to be omitted.

Simple blending of different-colored dispersions of the invention allows any desired hues to be set very simply.

The process B of the invention has the advantage that the colored organopolysiloxanes prepared in accordance with the invention are obtained directly in the form of emulsions and can be applied as they are directly, depending on the envisaged use.

The inventive reaction of the starting compounds to form the colored organopolysiloxanes of the invention may also take place homogeneously, i.e. in a one-phase reaction (process C). In this case the dye used in accordance with the invention and the organopolysiloxane used in accordance with the invention are dissolved in a joint aprotic organic solvent that is inert toward the reactants, or in aqueous-organic solvent mixtures, preferably in dimethylformamide and dimethyl sulfoxide, more preferably dimethyl sulfoxide. The reaction likewise proceeds optionally without catalyst, or under basic catalysis, as already described above.

The reaction of process C according to the invention is carried out at a temperature of preferably 5 to 100° C., more preferably at 60 to 80° C., and preferably under the pressure of the surrounding atmosphere, i.e., at 900 to 1100 hPa. The reaction times are preferably 15 to 300 minutes.

The colored organopolysiloxanes of the invention can then be isolated, for example, by simple distillative removal of the solvent or solvent mixture.

Process C of the invention has the advantage that it can be carried out with simple apparatus in a simple way.

All of the versions of the process of the invention that have been described have the advantage that the organopolysiloxanes of the invention can be produced easily, reproducibly, and with a very good yield, of preferably 90% to 99%.

The organopolysiloxanes of the invention are carried out preferably by process A or B, more preferably by process A, in each case in combination if desired with an equilibration step.

If desired, the colored organopolysiloxanes of the invention, of the formula (II), may be equilibrated with further organopolysiloxanes, preferably from the group consisting of linear organopolysiloxanes containing terminal triorganosiloxy groups, linear organopolysiloxanes containing terminal hydroxyl groups, cyclic organopolysiloxanes, and copolymers of diorganosiloxane units and monoorganosiloxane units, thereby, for example, allowing the setting of the desired molecular weight and also the targeted distribution of the dye groups in the molecule, and, where appropriate, the introduction of further functionalities.

As linear organopolysiloxanes containing terminal triorganosiloxane groups it is preferred to use those of the formula (V)

R¹⁵₃SiO(SiR¹⁵₂)ᵤSiR¹⁵₃ (V);

as linear organopolysiloxanes containing terminal hydroxyl groups is preferred to use those of the formula (VI)

HO(SiR¹⁵₂O)ᵥH (VI);

as cyclic organopolysiloxanes it is preferred to use those of the formula (VII)

(SiR¹⁵₂O)ₜ (VII);

and as copolymers it is preferred to use those made up of units of the formula (VIII)

R¹⁵₃SiO_{1/2}, R¹⁵₂SiO and R¹⁵SiO_{3/2} (VIII),

where R¹⁵ in each case can be identical or different and has a definition indicated for R.

u is 0 or an integer from 1 to 1500,

v is 0 or an integer from 1 to 1500, and

t is an integer in the range from 3 to 12.

The proportions of the organopolysiloxanes used in the equilibration (if conducted) and colored organopolysiloxanes of the invention are determined solely by the desired fraction of the dye groups in the end product and also by the desired average chain length.

In the course of the equilibration, if carried out, it is preferred to use basic catalysts which promote the equilibration. Examples of such catalysts are benzyltrimethylammonium hydroxide, tetramethylammonium hydroxide, alkali metal hydroxides and alkaline earth metal hydroxides in methanolic solution, and silanolates. Preference is given here to alkali metal hydroxide, which are used in amounts of preferably 50 to 10 000 ppm by weight (parts per million), more particularly 500 to 2000 ppm by weight, based in each case on the total weight of the organosilicon compounds employed.

The equilibration, if carried out, is carried out preferably at 50 to 150° C., more preferably 70 to 120° C., more particularly 80 to 100° C., and preferably under the pressure of the surrounding atmosphere, i.e. between 900 and 1100 hPa. It can also be carried out, however, at higher or lower pressures.

The equilibration can if desired be carried out in a solvent which is not miscible with water, such as toluene, but this is not preferred. If such organic solvents are to be used, amounts of 5 to 20 percent by weight are preferred, based on the total weight of the organosilicon compounds employed.

Prior to the working-up of the mixture obtained in the inventive equilibration, the catalyst may be rendered ineffective.

The colored organopolysiloxanes of the invention are generally suitable for any kind of application where considerations are the combination of properties typical to silicones, such as hydrophobicizing, dirt repellency, soiling, soft hand, gloss, etc., with a visible or latent coloration.

The present specification therefore provides for the use of the colored organopolysiloxanes of the invention as colorants.

In the cosmetic applications field, suitable applications include in particular those in decorative cosmetology, skincare, and haircare. Typical haircare applications are for example the permanent, semipermanent or temporary coloring of keratinic fibers by cosmetic formulations which comprise the organopolysiloxanes of the invention as coloring ingredients. Further benefits which may be obtained, besides the coloring or shading, include, for example, the heightening of the hair's gloss, of its volume, and of its curl retention, an improved softness to the touch, an improvement in dry or wet combability through a reduction in the combing resistance, a reduction in the antistatic charging, and the general protection of the keratinic fiber against splitting, becoming dry, and structurally harmful environmental effects.

In the skincare sector as well it is possible to use the organopolysiloxanes of the invention—for example, as a lipophilic formulating ingredient in makeup, lipstick, lipgloss, mascara, eyeliner, nail varnish, massage oil or massage gels, skin creams or in sun care products. Benefits typical of silicones include in this context, for example, a pleasant skin sensation, a general reduction in the stickiness of the cosmetic formulation, a reduction in the propensity of any pigments or fillers present to undergo aggregation, and also the development of a hydrophobic but breathable barrier on the skin surface, which leads, for example, to improved water resistance on the part of the cosmetic product.

In addition it is possible to color cosmetics or household products with the organopolysiloxanes of the invention in order to draw particular attention to active components or, for marketing reasons, for example, to carry out optical upgrading of products (increasing the products attractiveness).

The organopolysiloxanes of the invention are also outstandingly suitable, furthermore, for paper, tissue, leather, and textile applications. The treatment of these substrates may on the one hand be carried out only for purely decorative or fashion reasons or may serve a substrate care purpose, as for example when the color of colored textiles is re-established or re-emphasized by means of recoloring products. On the other hand, as well as imparting color, it is possible to obtain a series of positive benefits which are otherwise achievable only by means of multistage treatment methods. By way of example, paper towels, textiles, yarns, woven fabrics, natural or synthetic fibers can in one operation be colored and at the same time be provided with the desired hand properties (soft, flowing, velvety, smooth or the like). In the same way the coloring operation can also be combined with substrate hydrophilization or, in particular, with substrate hydrophobization. In contrast to hydrophilic finishes in the tissue and textile sector, mention may be made here, by way of example, of the treatment of leather, where in the wet-end process, for example, the colored organosilicon compounds can be used to obtain full and uniform deep-down coloring in conjunction with water repellency. In the fabric care sector, conversely, the hydrophilization and softening of textiles are desired, in combination with a deepening of color, regeneration of color or optical brightening in the course of the laundering operation.

The organopolysiloxanes of the invention can also be used, furthermore, in adhesive, reprographic, and printing applications. In the case of release papers siliconized differently on either side or siliconized on one side, for example, it is useful to be able to distinguish the sides visually by means of colored marking. The organopolysiloxanes of the invention are especially suitable for this purpose, since unlike conventional organic dyes they do not affect the adhesive properties of the release papers. Moreover, the organopolysiloxanes of the invention can be used as an ingredient of toners or in formulations for color printing. When employed as a color assist additive in textile pigment printing, the organopolysiloxanes of the invention lead to a range of desired benefits, such as deepening of color, greater brilliance of color, provision of gloss, or improved rub fastness properties, for example.

Conventional architectural preservation and textile construction are two further fields of application for the organopolysiloxanes of the invention. Both in architectural preservation (maintaining built structures, ensuring the long-term stability of buildings, and imparting water repellency to building materials) and in textile construction, silicon-based products play an important part. In the context of the color modification of such products, the requirement is not only for 100% compatibility between the components, the majority of which are silicon-based, but also for assistance in respect of water repellency, water vapor permeability, and long-term resistance of the coating toward environmental effects. All of these requirements are met by the organopolysiloxanes of the invention, which are therefore outstandingly suitable for use as a colored formulating ingredient of architectural preservation coatings, wall paints or varnishes, for the coloring of mass-hydrophobized or surface-hydrophobized mineral building materials, and also for the color modification of textile coatings and siliconized textile wovens, knits or form-loop products, of the kind used, for example, for window panels, conveyor belts, safety clothing or protective clothing.

The organopolysiloxanes of the invention are suitable, furthermore, for polish applications, with very different effects being obtainable depending on the nature of the substrate and the thickness of the applied layer. For example, the organopolysiloxanes of the invention can be used in paint care (in the automobile sector, for example), in polishes for leather, furniture or lacquered articles, and also in hard wax care products, where typical target effects include color intensification, color regeneration, color shading, and the masking of irregularities or scratches. In the shoe polish sector the organopolysiloxanes of the invention contribute to hydrophobizing the outer leather, deepening color, and boosting shine.

Furthermore, the organopolysiloxanes of the invention are extremely suitable for coloring polymers, polymer blends, polymer compounds or any of a very wide variety of plastics which can be produced from them. More particularly they are suitable for coloring thermoplastics, such as polyethylene, polypropylene, polystyrene, polyamides, polyesters, polycarbonates, polyoxymethylene, polyvinyl chloride or acrylonitrile-butadiene-styrene copolymers, and for coloring silicon polymers of all kinds, such as silicones and silicone elastomers, resins, and waxes, for example, the organopolysiloxanes of the invention being distributed homogeneously in the polymer as molecular, coloring constituents and as such being no longer extractable from the polymer. Here, the advantage of the colored organopolysiloxanes of the invention becomes clear, namely the introduction on the silicone backbone of further functional groups, in addition to the chromophoric groups, since these further functional groups can be chosen in such a way as to achieve vulcanization of the silicon polymer of all kinds, which results in maximum transparency and compatibility and also with preventing the migration of the chromophoric components. In addition, the high transparency of the organopolysiloxanes of the invention makes it possible to obtain very clear transparent coloring of polymers in conjunction with high translucency over a broad spectral range.

In addition to the applications mentioned so far, the organopolysiloxanes of the invention are also suitable as marker substances for the investigation of processes of migration, penetration, sedimentation or coating, as for example in the context of the determination of penetration depths, of applied layer thicknesses, weights, and homogeneities, in the monitoring of flows of product or compound, and in the investigation of the processes underlying a finishing operation (such as the finishing of natural or synthetic fibers with silicone products, for example). If the dye radicals of the organopolysiloxanes of the invention are UV-active, fluorescent, phosphorescent, or enzymatically, chemically or physically stimulatable chromophores, the organopolysiloxanes of the invention can also be used as a hidden company seal for the discreet marking of products or formulations.

In general the organopolysiloxanes of the invention are also suitable for obtaining a visual indication of the homogeneity of a product or a product formula or of its correct application. The latter is highly important in particular in areas where it is necessary for one or more products to be applied to or distributed on an area as uniformly as possible, as in the case, for example, of adhesive paper coatings, of sunscreens or as similar sun care products, of pharmaceutical products, and of medical products (in cases of extensive topical application, for example).

The organopolysiloxanes of the invention are also suitable, finally, for tinting lipophilic substrates in the food, agricultural, and pharmaceutical sectors.

The examples below should illustrate the invention in more detail without being limited to the examples given.

All parts given with percentages refer to the weight unless otherwise indicated. Unless indicated otherwise, the examples below are carried out under the pressure of the surrounding atmosphere, in other words at approximately 1000 hPa, and at room temperature, in other words at about 20° C., or at a temperature which comes about when the reactants are combined at room temperature without additional heating or cooling. All viscosity figures given in the examples relate to a temperature of 25° C.

### EXAMPLE 1

2.06 parts of dye having the following structure

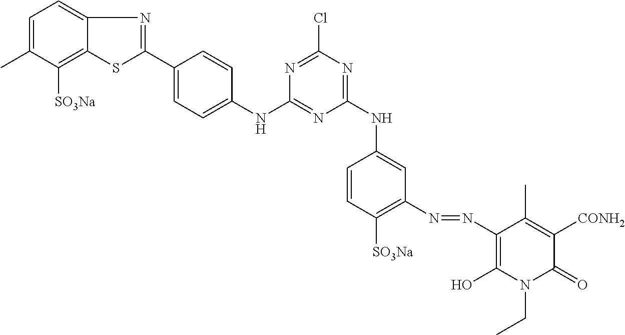

were suspended in 45 parts of fully demineralized water. 50 parts of an aminoalkyl-carrying polydimethylsiloxane (amine number: 92 μmol of amine groups per gram; viscosity: 300 mm²/s) were worked on for 3 minutes with a high-performance disperser (e.g. Ika Ultra-Turrax®)—thereby heating them to about 30° C.—and the aqueous solution of the dye was subsequently dispersed homogeneously in the siloxane for 10 minutes using the high-performance disperser, in the course of which the reaction mixture underwent heating to about 60° C. The remaining water was removed under reduced pressure and, after cooling to room temperature, the product was filtered through a depth filter. This gave 100 parts of a yellow-colored silicone oil.

### EXAMPLE 2

4.52 parts of a mixture of three dyes having the following structures

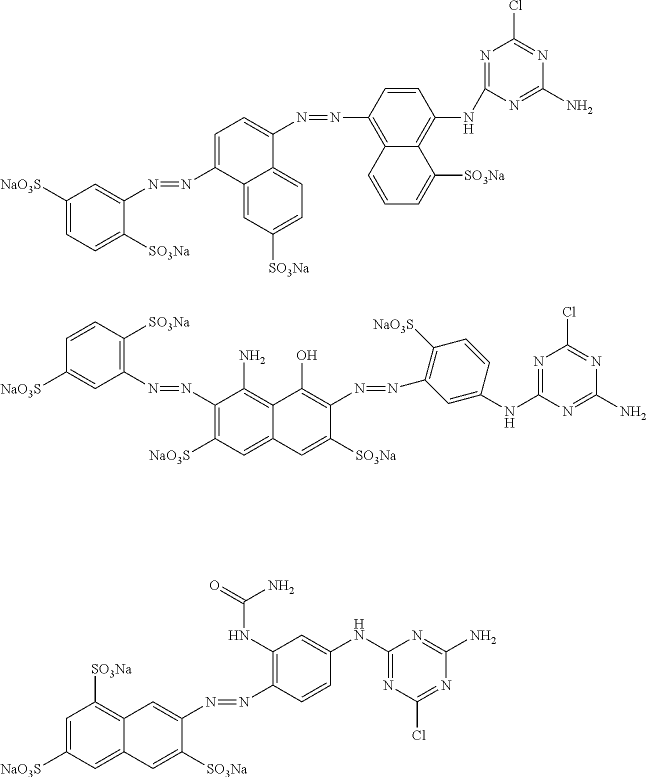

were suspended in 9 parts of fully demineralized water. 100 parts of an aminoalkyl-carrying polydimethylsiloxane (amine number: 92 μmol of amine groups per gram; viscosity: 300 mm²/s) were worked on for 3 minutes with a high-performance disperser (e.g. Ika Ultra-Turrax®)—thereby heating them to about 30° C.—and the aqueous solution of the dye was subsequently dispersed homogeneously in the siloxane for 10 minutes using the high-performance disperser, in the course of which the reaction mixture underwent heating to about 60° C. The remaining water was removed under reduced pressure and, after cooling to room temperature, the product was filtered through a depth filter. This gave 99 parts of a black-colored silicone oil.

### EXAMPLE 3

7.37 parts of the dye mixture described in example 2 were suspended in 15 parts of fully demineralized water. 50 parts of an aminoalkyl-carrying polydimethylsiloxane (amine number: 300 μmol of amine groups per gram; viscosity: 301 mm²/s) were worked on for 3 minutes with a high-performance disperser (e.g. Ika Ultra-Turrax®)—thereby heating them to about 30° C.—and the aqueous solution of the dye was subsequently dispersed homogeneously in the siloxane for 10 minutes using the high-performance disperser, in the course of which the reaction mixture underwent heating to about 60° C. The remaining water was removed under reduced pressure and, after cooling to room temperature, the product was filtered through a depth filter. This gave 100 parts of a black-colored silicone oil.

### EXAMPLE 4

162.4 parts of the dye mixture described in example 2 were suspended in 300 parts of fully demineralized water. 400 parts of an aminoalkyl-carrying polydimethylsiloxane (amine number: 459 μmol of amine groups per gram; viscosity: 328 mm²/s) were worked on for 3 minutes with a high-performance disperser (e.g. Ika Ultra-Turrax®)—thereby heating them to about 25° C.—and the aqueous solution of the dye was subsequently dispersed homogeneously in the siloxane for 10 minutes using the high-performance disperser, in the course of which the reaction mixture underwent heating to about 50° C. The remaining water was removed under reduced pressure and, after cooling to room temperature, the product was filtered through a depth filter. This gave 98 parts of a black-colored silicone oil.

### EXAMPLE 5

118.6 parts of the dye mixture described in example 2 were suspended in 200 parts of fully demineralized water. 500 parts of an aminoalkyl-carrying polydimethylsiloxane (amine number: 254 μmol of amine groups per gram; viscosity: 232 mm²/s) were worked on for 3 minutes with a high-performance disperser (e.g. Ika Ultra-Turrax®)—thereby heating them to about 25° C.—and the aqueous solution of the dye was subsequently dispersed homogeneously in the siloxane for 10 minutes using the high-performance disperser, in the course of which the reaction mixture underwent heating to about 50° C. The remaining water was removed under reduced pressure and, after cooling to room temperature, the product was filtered through a depth filter. This gave 100 parts of a black-colored silicone oil (viscosity: 2140 mPa·s).

### EXAMPLE 6

3.08 parts of a metal complex dye having the following composition

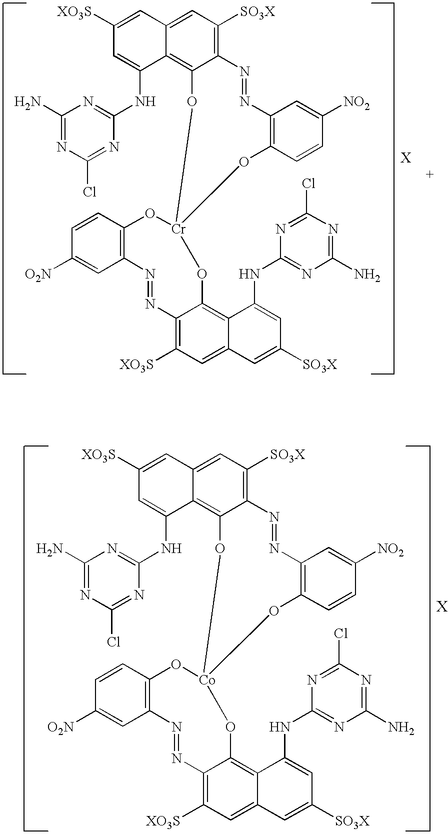

where X is sodium, were suspended in 7 parts of fully demineralized water. 50 parts of an aminoalkyl-carrying polydimethylsiloxane (amine number: 92 μmol of amine groups per gram; viscosity: 300 mm²/s) were worked on for 3 minutes with a high-performance disperser (e.g. Ika Ultra-Turrax®)—thereby heating them to about 30° C.—and the aqueous solution of the dye was subsequently dispersed homogeneously in the siloxane for 10 minutes using the high-performance disperser, in the course of which the reaction mixture underwent heating to about 60° C. The remaining water was removed under reduced pressure and, after cooling to room temperature, the product was filtered through a depth filter. This gave 102 parts of a black-colored silicone oil (viscosity: 2140 mPa·s).

### EXAMPLE 7

6.89 parts of the dye described in example 6 were suspended in 15.4 parts of fully demineralized water. 110 parts of an aminoalkyl-carrying and vinyl-carrying polydimethylsiloxane (amine number: 92 μmol of amine groups per gram; iodine number: 3.1 g (I₂)/100 g; viscosity: 396 mm²/s) were worked on for 3 minutes with a high-performance disperser (e.g. Ika Ultra-Turrax®)—thereby heating them to about 30° C.—and the aqueous solution of the dye was subsequently dispersed homogeneously in the siloxane for 10 minutes using the high-performance disperser, in the course of which the reaction mixture underwent heating to about 60° C. Subsequently the mixture was heated with stirring at 100° C. for 4 h. The remaining water was removed under reduced pressure and, after cooling to room temperature, the product was filtered through a depth filter. This gave 99 parts of a black-colored silicone oil (viscosity: 2140 mPa·s).

### EXAMPLE 8

2.46 parts of a metal complex dye having the following composition

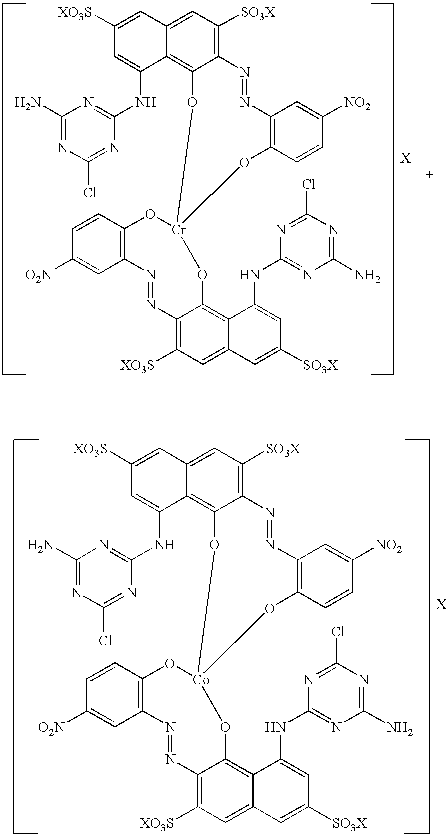

where X is a cation having the following structure

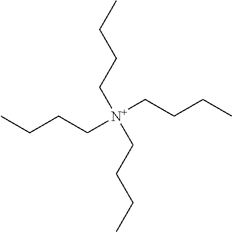

were metered into 110 parts of an aminoalkyl-carrying and vinyl-carrying polydimethylsiloxane (amine number: 92 μmol of amino groups per gram; iodine number: 3.1 g (I₂)/100 g; viscosity: 396 mm²/s) and dispersed homogeneously in the siloxane for 10 minutes using a high-performance disperser (e.g., Ika Ultra-Turrax®). Subsequently the mixture was heated with stirring at 100° C. for 4 h. After cooling to room temperature, the product was filtered through a depth filter. This gave 100 parts of a black-colored silicone oil.

### EXAMPLE 9

110 parts of a 9·10⁻³ M solution in methanol of a metal complex dye having the following composition

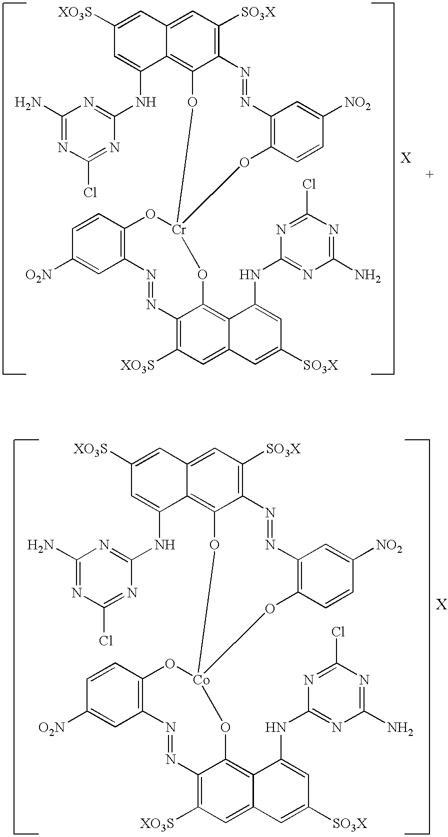

where X is a cation having the following structure

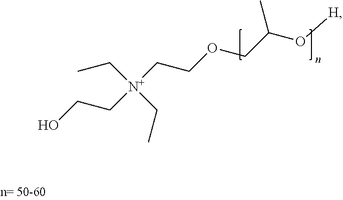

were metered into 110 parts of an aminoalkyl-carrying and vinyl-carrying polydimethylsiloxane (amine number: 92 μmol of amino groups per gram; iodine number: 3.1 g (I₂)/100 g; viscosity: 396 mm²/s). Subsequently the mixture was heated with stirring at 100° C. for 4 h. After cooling to room temperature, all of the volatile components were removed under reduced pressure and the product was filtered through a depth filter. This gave 99 parts of a black-colored silicone oil.

To investigate the light stability, black silicone elastomer specimens were produced from the black silicone oil produced as per example 6. This was done by mixing 1.75% of the black silicone oil from example 6 into a liquid silicone rubber mixture of the type WACKER Elastosil® LR 3003/10 (WACKER Chemie AG). The mixture was subsequently cast in sheet form (80×20×2 mm³) and subjected to a UV exposure test. UV exposure test conditions: total duration of UV exposure: 1000 h in cycles; UV-A radiation (340 nm), 0.92 W/m²/nm; one cycle: 8 h of UV exposure at 50° C.+4 h of irrigation at 40° C.; exposure was carried out with and without a glass cover. The colored sheet, after 1000 h of UV exposure, showed no visible bleaching (deep black hue unchanged) either under the glass cover or without the glass cover.

To investigate the thermal stability, black silicone elastomer specimens were produced from the black silicone oils described in examples 5 and 9. This was done by mixing 1%, 2%, 4%, and 6% of the black silicone oil from example 5 and 2%, 4%, 6%, and 10% of black silicone oil from example 9 each into a liquid silicone rubber mixture of the type WACKER Elastosil® LR 3003/40 (WACKER Chemie AG). The two mixtures were subsequently cast in sheet form (80×20×2 mm³) and subjected to a temperature stability test. This was done by storing the resulting sheets at 200° C. for 4 h. The hues of the heat-treated rubber sheets were identical (deep black hue unchanged) by comparison with the samples not subjected to heat treatment.

1-7. (canceled)

8. A colored organopolysiloxane comprising units of the formula
R¹ₐ(RO)_{b}A_{c}R²_{d}SiO_{(4-a-b-c-d)/2} (I),
in which
R is hydrogen or a monovalent, unsubstituted or substituted hydrocarbon radical, wherein R is identical or different among the units of the formula (I);
R¹ is hydrogen or a monovalent, SiC-bonded, unsubstituted or substituted hydrocarbon radical, wherein R¹ is identical or different among the units of the formula (I);
R² is a substituted monovalent hydrocarbon radical, wherein R² is identical or different among the units of the formula (I);
A is a hydrophilic organic dye radical or its complex compound with a metal, which contains at least one triazine ring via which it is bonded to the unit of the formula (I), wherein A is identical or different among the units of the formula (I);
a is 0, 1, 2 or 3;
b is 0, 1, 2 or 3;
d is 0, 1, 2 or 3; and
c is 0, 1 or 2;
wherein a+b+c+d≦3;
wherein d is 0 in the units of the formula (I) where c is not 0; and
wherein the organopolysiloxane has at least one radical A per molecule.

9. The colored organopolysiloxane of claim 8, wherein R is hydrogen, methyl, ethyl, vinyl or propyl.

10. The colored organopolysiloxane of claim 8, wherein R¹ is methyl.

11. The colored organopolysiloxane of claim 8 having the general formula (III)
R¹₃SiO(SiA₂O)ₑ(SiR¹_{f}R²_{2-f}O)_{g}(R²ₘR¹₂₋ₘSiO)ₕ(R¹₁₋ⱼSiO)ₖSiR¹₃ (III)
in which
R¹, R² and A are defined as in claim 8;
f is 0 or 1,
j is 0or 1;
m is 0, 1 or2;
e is 0 or an integer from 1 to 100;
g is 0 or an integer from 1 to 100;
h is 0 or an integer from 1 to 1000; and
k is an integer from 1 to 100;
wherein (e+g)<(h+k)/10 and the subunits in the formula (III) are distributed randomly in the siloxane molecule.

12. The colored organopolysiloxane of claim 11, wherein f is 1, j is 1, and m is 0.

13. The colored organopolysiloxane of claim 8, wherein the dye content is 0.1% to 80% by weight of the total weight of the colored organopolysiloxane.

14. The colored organopolysiloxane of claim 13, wherein the dye content is 1% to 15% by weight of the total weight of the colored organopolysiloxane.

15. The colored organopolysiloxane of claim 14, wherein the dye content is 5% to 10% by weight of the total weight of the colored organopolysiloxane.

16. A process for preparing a colored organopolysiloxane comprising:
reacting a hydrophilic organic dye of the formula IV 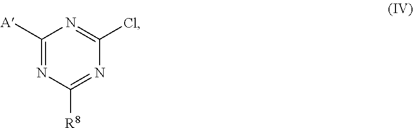
in which A′ is a chromophoric structure and R⁸ is A′ or an organic radical,
with an organopolysiloxane comprising one or more functional groups which are reactive with the chlorotriazine group of the dye to form a covalent bond.
